(19) United States
(12) Patent Application Publication
(10) Pub. No.: US 2019/0146586 A1
(43) Pub. Date: May 16, 2019

(54) INPUT DEVICE

(71) Applicant: Sharp Kabushiki Kaisha, Osaka (JP)

(72) Inventor: Kunihiko YAMAMOTO, Sakai City (JP)

(21) Appl. No.: 16/186,621

(22) Filed: Nov. 12, 2018

(30) Foreign Application Priority Data
Nov. 14, 2017 (JP) 2017-218940

(51) Int. Cl. G06F 3/01; G02F 1/1333; G06F 3/041; G06F 3/044

(52) U.S. Cl. CPC G06F 3/016; G02F 1/13338; G02F 1/13306; G06F 3/044; G06F 3/0416

(57) ABSTRACT

An input device includes an input receptive body, a base, an oscillator, a vibration detector, and a vibration controller. The input receptive body is configured to receive input operation. The base is attached to the input receptive body. The oscillator is configured to vibrate the input receptive body. The vibration detector is configured to detect vibration of the input receptive body. The vibration controller is configured to output a base vibration signal to oscillate the oscillator with which the input receptive body vibrates, obtain a waveform of the vibration of the input receptive body based on an output signal from the vibration detector, and generate a suppression signal with an opposite phase from a phase of at least a section of the waveform of the vibration to control driving of the oscillator.

### CROSS REFERENCE TO RELATED APPLICATION

This application claims priority from Japanese Patent Application No. 2017-218940 filed on Nov. 14, 2017. The entire contents of the priority application are incorporated herein by reference.

### TECHNICAL FIELD

The technology described herein relates to an input device.

### BACKGROUND

A known electronic device includes a touch panel, a touch panel controller, an oscillator, and a vibration controller. The touch panel controller includes a function of detecting a touch of the touch panel by a user. The oscillator vibrates the touch panel. The vibration controller includes a function of generating signals to drive the oscillator. The signals generated by the vibration controller include control signals to control inertial vibration of the touch panel. An example of such an electronic device is disclosed in WO 2015/136923.

In the electronic device, a drive signal is supplied to the oscillator to vibrate the touch panel and then a suppression signal is supplied to the oscillator to reduce the inertial vibration of the touch panel. The drive signal that is supplied prior to the suppression signal and the suppression signal are out of phase by 180°. The dimension and the weight of the touch panel may be different from those of other touch panels. Therefore, the touch panel may vibrate differently from others due to the differences in dimension and weight. Such individual differences are not considered in generation of the suppression signal and thus the inertial vibration of the touch panel may not be properly reduced and tactile feedback performance may be reduced. Improvement in tactile feedback performance is expected.

### SUMMARY

The technology described herein was made in view of the above circumstances. An object is to improve tactile feedback performance.

An input device includes an input receptive body, a base, an oscillator, a vibration detector, and a vibration controller. The input receptive body is configured to receive input operation. The base is attached to the input receptive body. The oscillator is configured to vibrate the input receptive body. The vibration detector is configured to detect vibration of the input receptive body. The vibration controller is configured to output a base vibration signal to oscillate the oscillator with which the input receptive body vibrates, obtain a waveform of the vibration of the input receptive body based on an output signal from the vibration detector, and generate a suppression signal with an opposite phase from a phase of at least a section of the waveform of the vibration to control driving of the oscillator.

According to the configuration, the oscillator starts oscillating when the base vibration signal from the vibration controller is input. In conjunction with oscillation of the oscillator, the input receptive body vibrates relative to the base. When vibration of the input receptive body is detected by the vibration detector, a signal is output by the vibration detector. The vibration controller obtains the waveform of the vibration of the input receptive body based on the output signal by the vibration detector and generates the suppression signal with the opposite phase from the phase of at least the section of the waveform of the vibration. Even if the waveform of the vibration of the input receptive body based on the base vibration signal is not stable due to individual differences of the input receptive body, the residual vibration of the input receptive body promptly subsides because the driving of the oscillator is controlled based on the suppression signal generated based on the obtained waveform of the vibration. According to the configuration, higher tactile feedback performance can be obtained regardless of the individual differences.

According to the technology described herein, the tactile feedback performance is improved.

### BRIEF DESCRIPTION OF THE DRAWINGS

FIG. 1 is a side view schematically illustrating a configuration of an input device according to an embodiment.

FIG. 2 is a plan view of the input device.

FIG. 3 is a block diagram illustrating an electrical configuration of the input device.

FIG. 4 is a block diagram of a drive circuit including in a control circuit board.

FIG. 5 is a block diagram of a feedback circuit included in the control circuit board.

FIG. 6 is a graph illustrating a waveform of a base vibration signal generated by a base vibration signal generator.

FIG. 7 is a graph illustrating a waveform of vibration of a liquid crystal display device based on the base vibration signal.

FIG. 8 is a graph illustrating a waveform of the vibration of the liquid crystal display device clamped by the clamping circuit.

FIG. 9 is a graph illustrating a waveform of a feedback signal output by a half-wave rectifier circuit and a gain control circuit.

FIG. 10 is a graph illustrating a waveform of a suppression signal generated by a suppression signal generator.

FIG. 11 is a block diagram of a drive circuit used in an experiment.

FIG. 12 is a graph illustrating an added signal output by an adder.

FIG. 13 is a graph illustrating a waveform of vibration of the liquid crystal display device based on the added signal.

### DETAILED DESCRIPTION

### First Embodiment

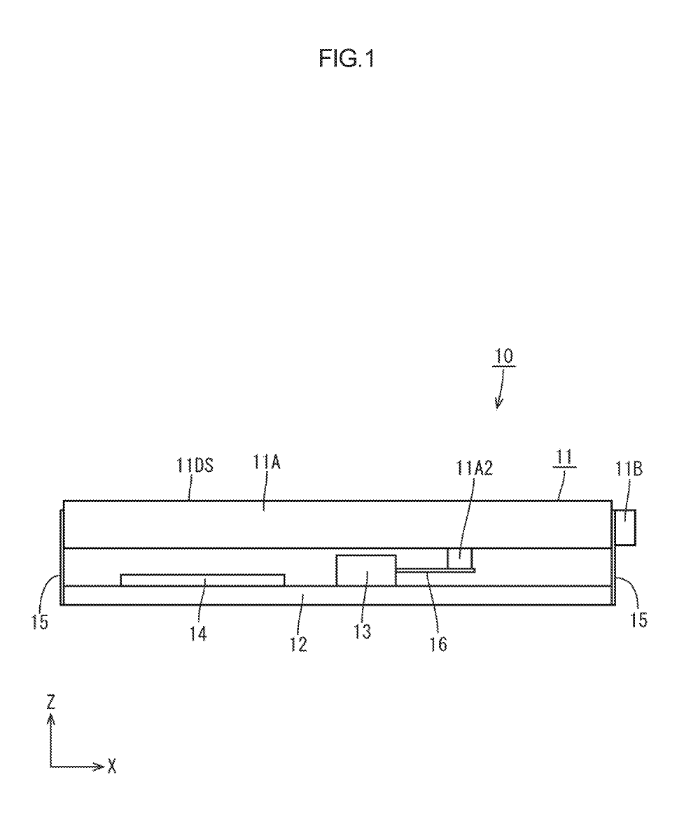

A first embodiment will be described with reference to FIGS. 1 to 13. An input device 10 including a tactile feedback function will be described. X-axes, Y-axes, and Z-axes may be present in the drawings. The axes in each drawing correspond to the respective axes in other drawings. The upper side and the lower side in FIG. 1 correspond to a front side and a back side of the input device 10, respectively.

As illustrated in FIG. 1, the input device 10 includes a liquid crystal display device 11 (an input receptive body), abase 12, an actuator 13 (an oscillator), a control circuit board 14 (a vibration controller), elastic members 15, and a plate spring 16. The liquid crystal display device 11 is configured to display images and receive inputs through touch operation by a user. The liquid crystal display device 11 is attached to the base 12. The liquid crystal display device 11 has a touch panel function (a position input function) in addition to the image display function. The base 12 is disposed behind the liquid crystal display device 11 opposite the liquid crystal display device 11 with a predefined gap.

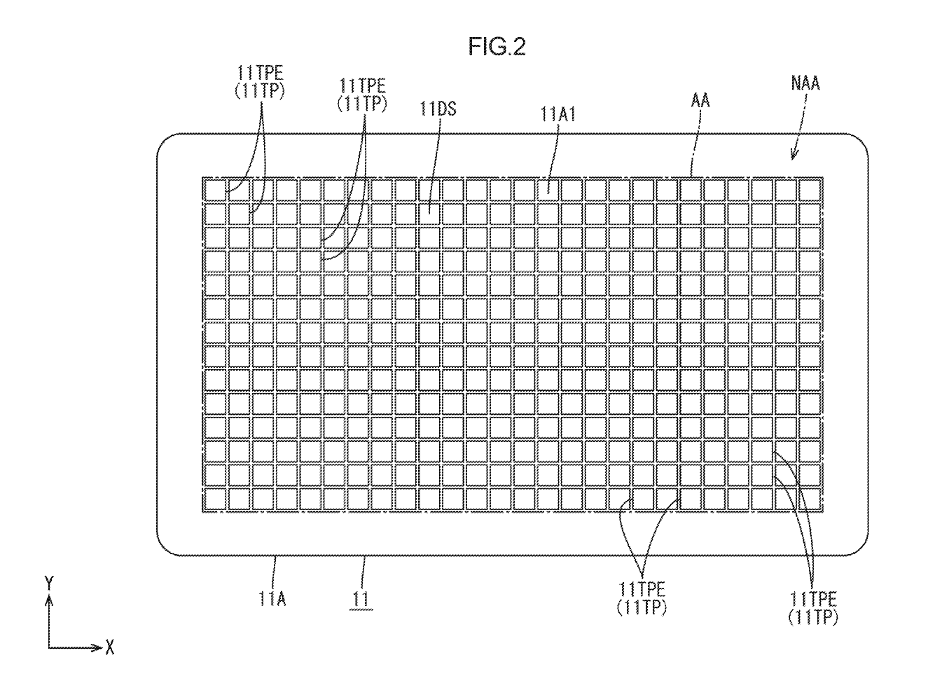

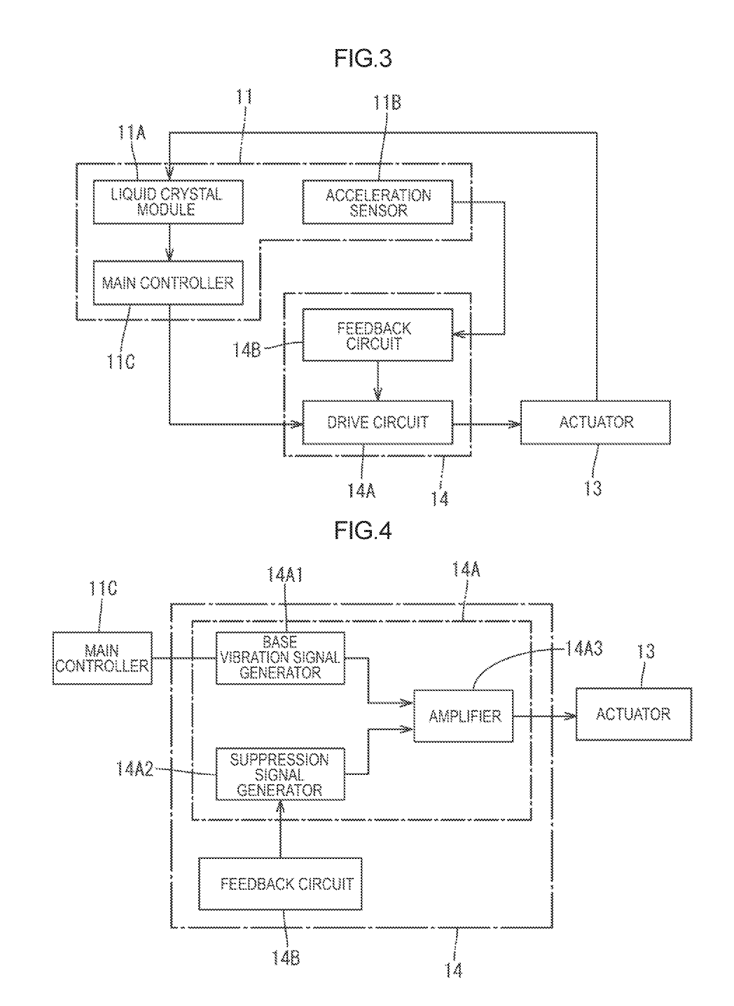

As illustrated in FIGS. 1 and 3, the liquid crystal display device 11 includes a liquid crystal module 11A, an acceleration sensor 11B, and a main controller 11C. The liquid crystal module 11A performs the image display function and the touch panel function. The acceleration sensor 11B is a vibration detector attached to the liquid crystal module 11A to detect vibration of the liquid crystal module 11A. As illustrated in FIG. 2, the liquid crystal module 11A includes at least a liquid crystal panel 11A1 (a display panel), a backlight unit, and a case. The liquid crystal panel 11A1 includes a display surface 11DS on which images are displayed. The backlight unit is disposed behind the liquid crystal panel 11A1 (on an opposite side from an input surface) to apply light to the liquid crystal panel 11A1 for image display. The case holds the liquid crystal panel 11A1 and the backlight unit therein. The liquid crystal panel 11A1 has a horizontally-long rectangular shape in a plan view. The display surface 11DS includes a display area (an active area) AA in which the images are displayed and a non-display area (a non-display area) NAA having a frame shape to surround a display area AA. In FIG. 2, a chain line indicates an outer boundary of the display area AA and an area outside the chain line is the non-display area NAA. The liquid crystal panel 11A1 includes an embedded touch panel pattern 11TP for detecting input positions at which touch operation is performed by the user. The touch panel pattern 11TP uses the projected capacitive technology and a self-capacitance method for detection. The touch panel pattern 11TP includes at least touch electrodes 11TPE (position detection electrodes) arranged in a matrix in the display area AA. The display area AA of the liquid crystal panel 11A1 substantially corresponds with a touch area in which the input positions are detectable. The non-display area NAA substantially corresponds with a non-touch area in which the input positions are not detectable. When the user touch the screen based on an image displayed in the display area AA with his or her fingertip. Capacitances are induced between the fingertip and the touch electrodes 11TPE. The capacitances measured at the touch electrodes 11TPE closer to the fingertip vary as the fingertip approaches and take different values from those of the touch electrodes 11TPE farther from the fingertip. The input position is determined based on the capacitances. A direction in which input operation is performed substantially corresponds with the Z-axis direction, that is, the normal direction to the display surface 11DS.

As illustrated in FIG. 3, the acceleration sensor 11B is configured to measure an acceleration of the vibration of the liquid crystal module 11A. The acceleration sensor 11B is a single-axis type acceleration sensor having a single detection axis. The acceleration sensor 11B is attached to the case of the liquid crystal module 11A with the detection axis corresponding with a vibration direction in which the liquid crystal module 11A vibrates (the X-axis direction). The acceleration sensor 11B has a detection range of ±3 g and a sensitivity of about 330 my/g. An output voltage of the acceleration sensor 11B at 0 g is about 1.65 V. A piezo type acceleration sensor including a piezo element may be used for the acceleration sensor 11B. The main controller 11C includes a CPU for controlling driving of the liquid crystal panel 11A1 to display predefined images on the display surface 11DS. After the input position in the touch operation is determined based on the potential differences on the touch panel pattern 11TP, the main controller 11C controls the liquid crystal panel 11A1 to display the image on the display surface 11DS.

The actuator 13 is for vibrating the liquid crystal display device 11. The control circuit board includes a drive circuit 14A to control driving of the actuator 13. The elastic members 15 are attached to the liquid crystal display device 11 and the base 12, respectively. The actuator 13 is an electromagnetic actuator (a solenoid actuator). The actuator 13 includes a fixed portion and a movable portion. The fixed portion is fixed to a surface of the base 12 on the liquid crystal display device 11 side. The movable portion is fixed to a surface of the liquid crystal display device 11 on the base 12 side via the plate spring 16 to be movable in the X-axis direction (the vibration direction) relative to the fixed portion. The fixed portion includes at least a fixed magnetic pole and a coil wound around the fixed magnetic pole. The movable portion includes at least a movable magnetic pole that is movable relative to the fixed magnetic pole. When the coil is energized and a magnetic field is generated around the fixed magnetic pole, the movable magnetic pole is attracted toward the fixed magnetic pole. The movable portion moves in the X-axis direction (a direction parallel to the display surface 11DS of the liquid crystal panel 11A1) toward the fixed portion. According to the movement of the movable portion, the liquid crystal display device 11 to which the movable portion is attached vibrates in the X-axis direction. The vibration direction of the liquid crystal display device 11 is perpendicular to the input direction of the touch operation (the Z-axis direction). The plate spring 16 extends in the X-axis direction. The plate spring 16 includes a first end connected to the movable portion and a second end connected to a bracket 11A2 fixed to the case of the liquid crystal module 11A. The bracket 11A2 has a block shape. The second end of the plate spring 16 moves in the X-axis direction with the first end fixed to the movable portion as a supporting point as the actuator 13 oscillates. Therefore, the liquid crystal module 11A moves in the X-axis direction along with a touch operation input.

As illustrated in FIG. 1, the elastic members 15 are plate springs that extend in the Z-axis direction. Each of the elastic members 15 includes a first end fixed to the case of the liquid crystal module 11A and a second end fixed to an end of the base 12. The elastic members 15 are elastically deformable in the X-axis direction perpendicular to the Z-axis direction, that is, an oscillation direction of the actuator 13. When the liquid crystal display device 11 vibrates in the X-axis direction in conjunction with the oscillation of the actuator 13, the elastic members 15 elastically deform in the X-axis direction and thus the liquid crystal display device 11 is movable in the X-axis direction relative to the base 12.

As illustrated in FIG. 1, the control circuit board 14 is attached to the surface of the base 12 on the liquid crystal display device 11. The control circuit board 14 includes electric components and electric lines of the drive circuit 14A and the feedback circuit 14B. The driving of the drive circuit 14A is controlled by the main controller 11C. The drive circuit 14A generates a base vibration signal based on a vibration signal output by the main controller 11C according to the determination of the input position. The base vibration signal is input to the actuator 13. The actuator 13 oscillates when the base vibration signal is input. The feedback circuit 14B generates a feedback signal based on an output signal from the acceleration sensor 11B. The feedback signal is input to the drive circuit 14A. The drive circuit 14A generates a suppression signal to reduce residual vibration of the actuator 13 based on the feedback signal from the feedback circuit 14B. The suppression signal is input to the actuator 13.

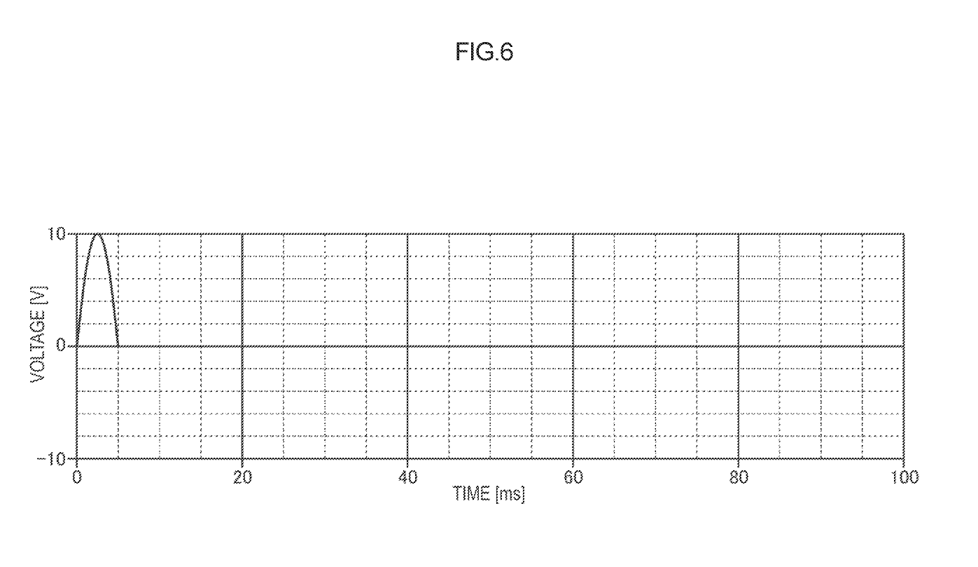

As illustrated in FIG. 4, the drive circuit 14A includes a base vibration signal generator 14A1, a suppression signal generator 14A2, and an amplifier 14A3. The base vibration signal generator 14A1 generates the base vibration signal. The suppression signal generator 14A2 generates the suppression signal based on the feedback signal. The amplifier 14A3 amplifies the base vibration signal output by the base vibration signal generator 14A1 and the suppression signal output by the suppression signal generator 14A2. The base vibration signal generator 14A1 generates a ½ sine-wave signal (see FIG. 6) or a pulse signal, which is the base vibration signal, based on the vibration signals output by the main controller 11C. FIG. 6 is a graph illustrating a waveform of the base vibration signal. The vertical axis represents voltage (in volts [V]) and the horizontal axis represents time (in milliseconds [ms]). The base vibration signals are positive signals with a peak voltage of about 10 V. With the vibration signals, the actuator 13 oscillates such that the movable portion moves to one side in the X-axis direction relative to the fixed portion.

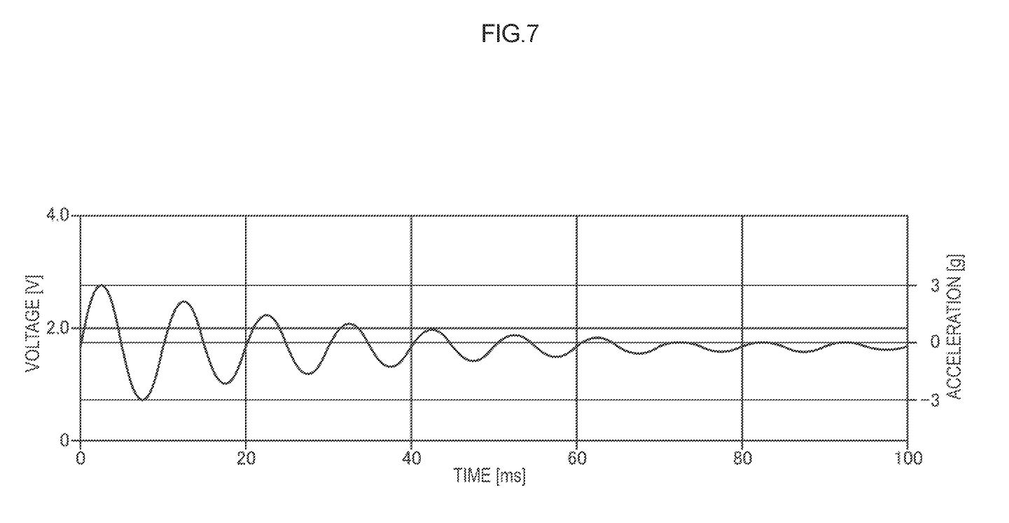

As illustrated in FIG. 7, the actuator 13 causes inertial vibration of the liquid crystal display device 11 in the X-axis direction. A waveform in FIG. 7 represents vibration of the liquid crystal display device 11 only based on the base signal without the suppression signal. In FIG. 7, the vertical axis on the left represents voltage (in volts [V]), the vertical axis on the right represents acceleration (in g [g]), and the horizontal axis represents time (in milliseconds [ms]). The waveform in FIG. 7 is included in the output signal from the acceleration sensor 11B attached to the liquid crystal module 11A. The vertical axis on the left represents voltage regarding the output signal from the acceleration sensor 11B. The vertical axis on the right represents acceleration calculated from the voltage regarding the output signal. Specifically, an acceleration at 1.65 V is defined as 0 g. According to FIG. 7, the liquid crystal display device 11 vibrates in the X-axis direction with the acceleration of 3 g at the maximum. The waveform in FIG. 7 has the maximum amplitude immediately at the time immediately after start of oscillation of the actuator 13. When the vibration with the maximum amplitude are transferred to the fingertip of the user, the user has a feeling of pressing a vertical button on the display surface 11DS in the Z-axis direction because of the phenomenon known as lateral force fields. The amplitude of the waveform in FIG. 7 decreases overtime. The liquid crystal display device 11 vibrates for more than 100 ms, that is, the vibration after the amplitude starts decreasing (specifically, after 10 ms) are unnecessary residual vibration. The residual vibration may be recognized by the user as lateral vibration, which may reduce tactile feedback performance.

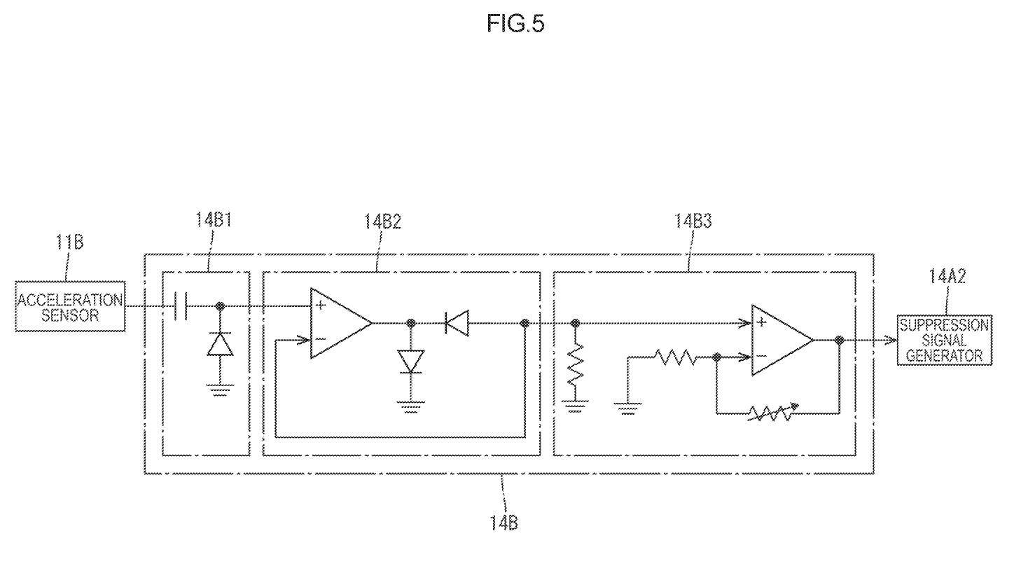

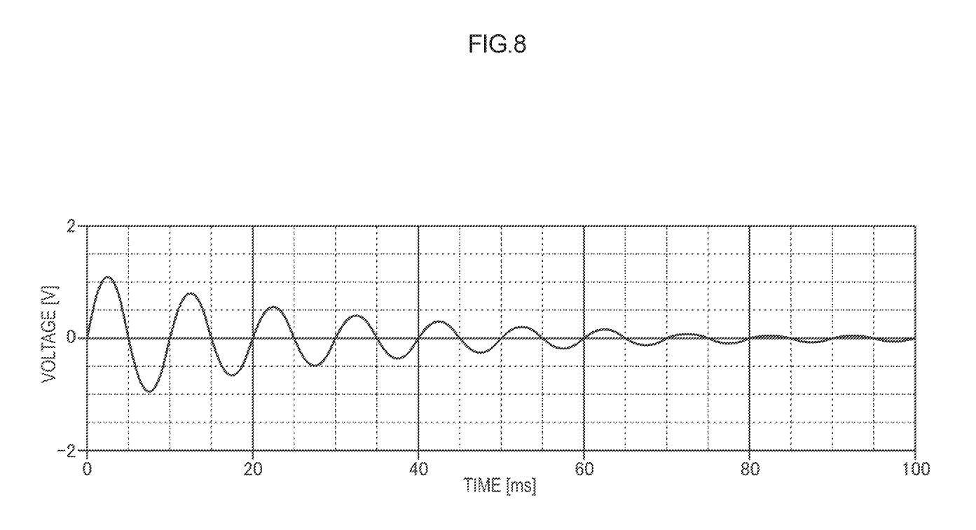

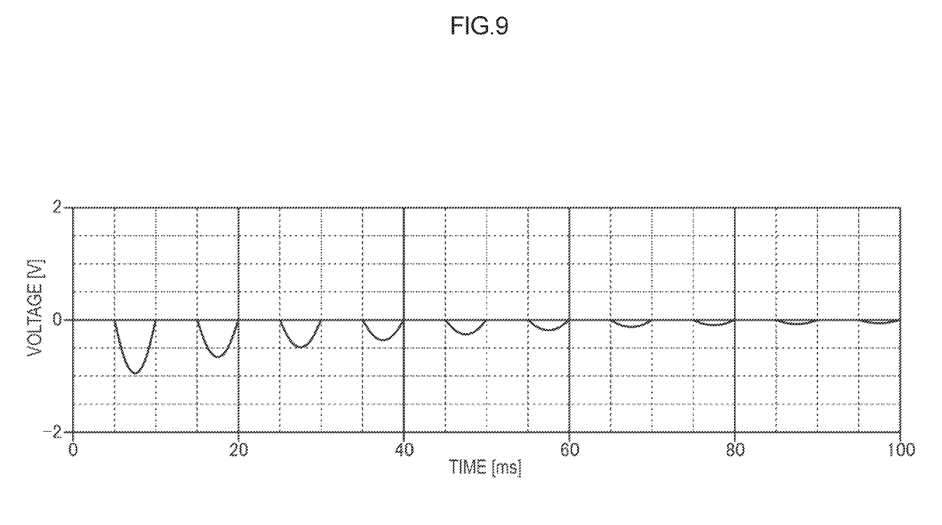

The feedback circuit 14B will be described. As illustrated in FIG. 5, the feedback circuit 14B includes a clamping circuit 14B1, a half-wave rectifier circuit 14B2, and a gain control circuit 14B3. The clamping circuit 14B1 clamps the output signal such that the middle of the peak-to-peak of the waveform of the output signal is set to the ground potential. The half-wave rectifier circuit 14B2 extracts either positive or negative sections of the output signal from the acceleration sensor 11B. The gain control circuit 14B3 amplifies the output signal from the half-wave rectifier circuit 14B2 to generate a feedback signal. The clamping circuit 14B1 clamps the output signal such that a center axis of the waveform in FIG. 7 is shifted to the ground potential (0 V). The clamping circuit 14B1 includes a capacitor and a diode. The waveform of the output signal clamped by the clamping circuit 14B1 is illustrated in FIG. 8. In FIG. 8, the vertical axis represents voltage (in volts [V]) and the horizontal axis represents time (in milliseconds [ms]). The half-wave rectifier circuit 14B2 is a non-inverting type half-wave rectifier circuit that outputs signals with a polarity the same as a polarity of input signals. The half-wave rectifier circuit 14B2 includes an operational amplifier (an op amp) and a diode. The half-wave rectifier circuit 14B2 extracts negative sections of the waveform in FIG. 7. The gain control circuit 14B3 is a non-inverting type amplifier circuit that output signals with a polarity the same as a polarity of input signals. The gain control circuit 14B3 includes an op amp and resistors (including a variable resistor). The gain control circuit 14B3 adjusts a gain of the output signal from the half-wave rectifier circuit 14B2 and outputs a feedback signal to the suppression signal generator 14A2. The waveforms of the feedback signal obtained through the half-wave rectifier circuit 14B2 and the gain control circuit 14B3 are illustrated in FIG. 9. The waveform of the feedback signal includes the negative sections of the waveform in FIG. 8. In FIG. 9, the vertical axis represents voltage (in volts [V]) and the horizontal axis represents time (in milliseconds [ms]).

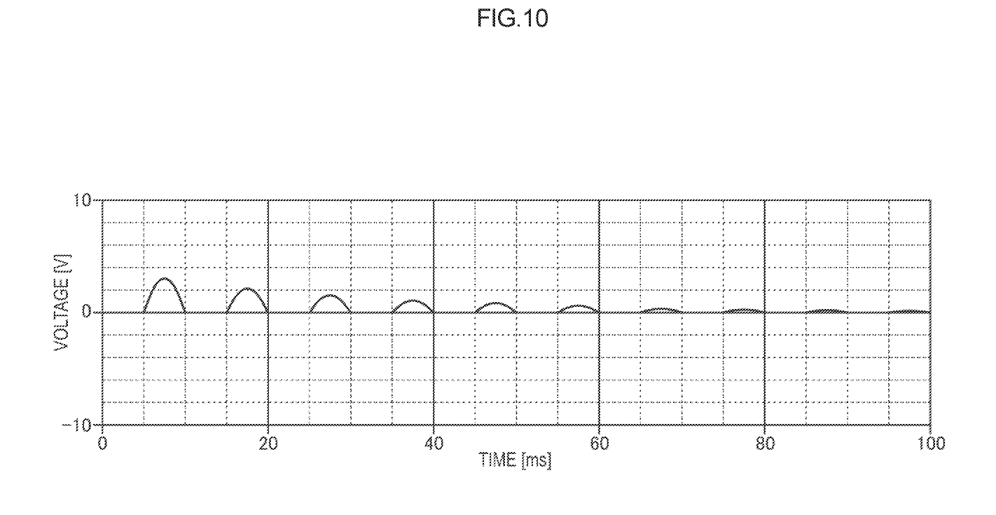

The suppression signal generator 14A2 will be described. As illustrated in FIG. 4, the suppression signal generator 14A2 generates a suppression signal based on the feedback signal output by the feedback circuit 14B. The suppression signal generated by the suppression signal generator 14A2 has a waveform that includes sections with an opposite phase from the phase of the waveform of the vibration of the liquid crystal display device 11 that vibrates in conjunction with the oscillation of the actuator 13 based on the base vibration signal (see FIG. 7). Specifically, the suppression signal generator 14A2 inverts the polarity of the feedback signal to generate the suppression signal. The waveform of the suppression signal is illustrated in FIG. 10. In FIG. 10, the vertical axis represents voltage (in volts [V]) and the horizontal axis represents time (in milliseconds [ms]). The suppression signal is a direct current signal with a polarity the same as the polarity of the base vibration signal. Therefore, the driving of the actuator 13 can be easily controlled. The suppression signal output by the suppression signal generator 14A2 is transmitted to the actuator 13 via the amplifier 14A3. With the suppression signal, the actuator 13 oscillates. The oscillation direction in which the actuator 13 oscillates based on the suppression signal is opposite from the vibration direction in which the liquid crystal display device 11 vibrates in conjunction with the oscillation of the actuator 13. The oscillation of the actuator 13 cancels the vibration of the liquid crystal display device 11. Therefore, the residual vibration of the liquid crystal display device 11 promptly subsides. If the weight and the dimensions of the liquid crystal module 11A are different from those of other liquid crystal modules in other liquid crystal display devices or the elastic constant, the thickness, and the dimensions of the elastic members 15 are different from those of other elastic members, the waveforms of vibration of the liquid crystal display device 11 and the liquid crystal display devices based on base vibration signals may not be uniform. Even in such a case, the residual vibration of the liquid crystal display device 11 promptly subsides because the driving of the actuator 13 is controlled based on the suppression signal generated by the suppressing signal generator 14A2 of the control circuit board 14 based on the waveforms of the vibration, which are periodically obtained. According to the configuration, the residual vibration can promptly subside and thus higher tactile feedback performance can be obtained regardless of the individual differences of the liquid crystal display device 11 and the elastic members 15.

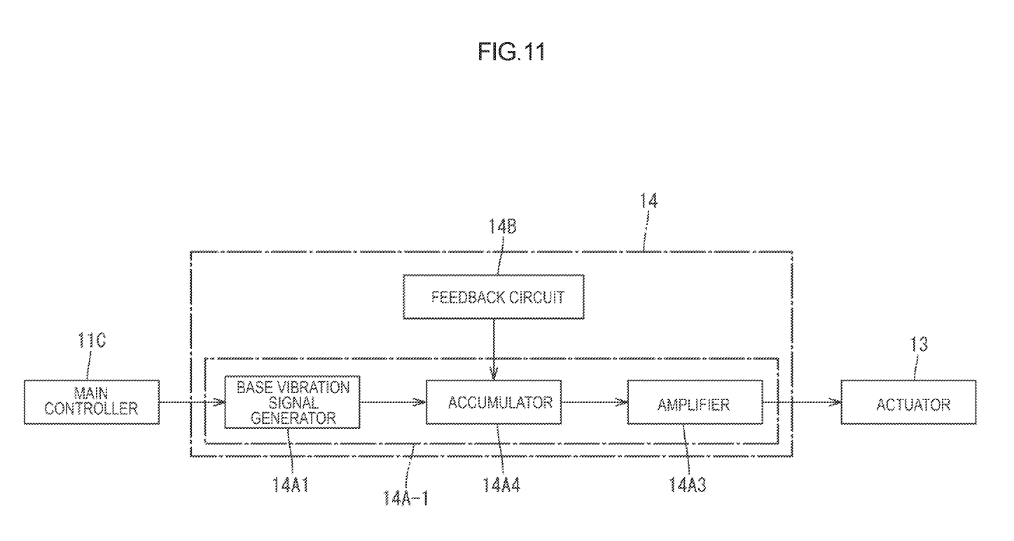

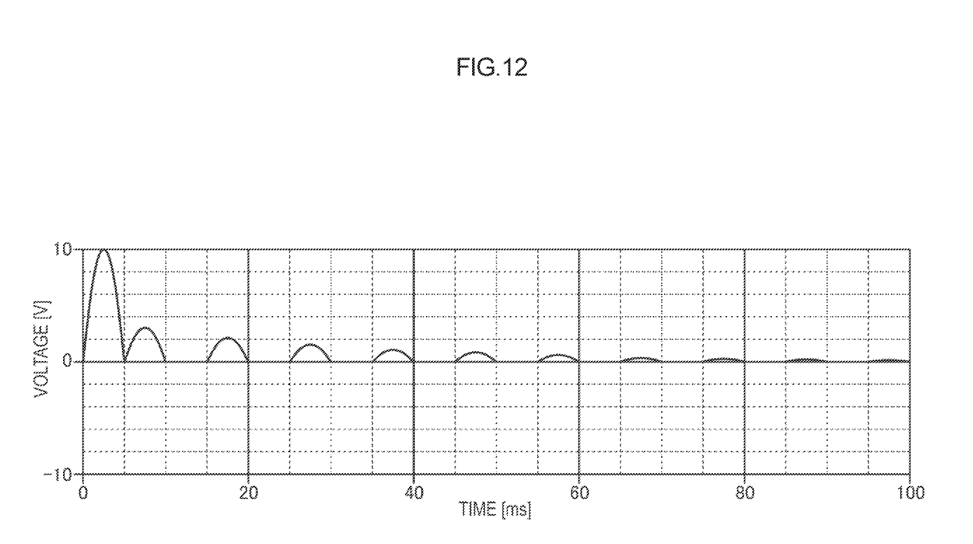

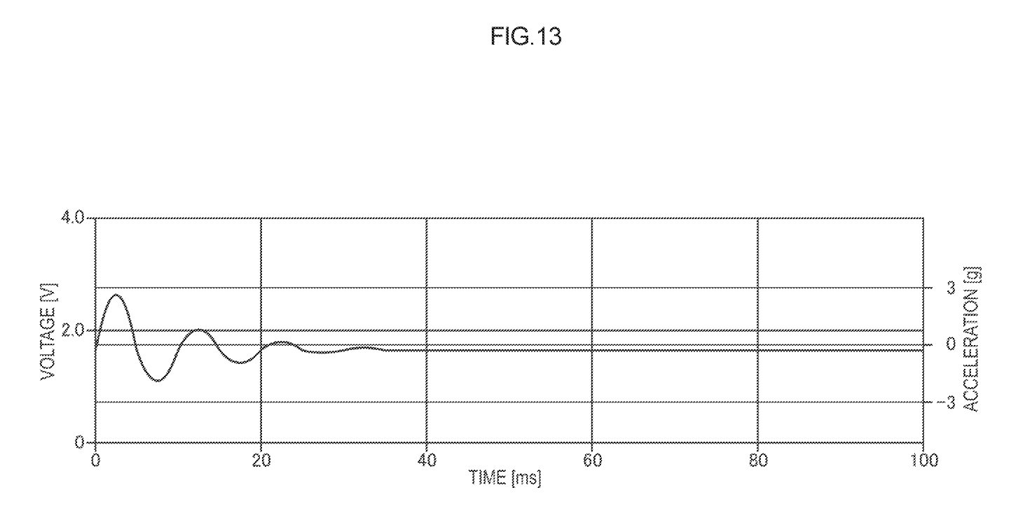

To examine residual vibration reduction effect of the suppression signals, an experiment was conducted. In the experiment, an example including a drive circuit 14A-1 having a configuration different from the drive circuit 14A was used. As illustrated in FIG. 11, the drive circuit 14A-1 includes the vibration signal generator 14A1 and the amplifier 14A3 used in the drive circuit 14A. The drive circuit 14A-1 further includes an adder 14A4 instead of the suppression signal generator 14A2. The adder 14A4 generates a suppression signal based on the feedback signal output by the feedback circuit 14B and adds the suppression signal to the base vibration signal. The signal obtained from the addition of the suppression signal and the base vibration signal is input to the amplifier 14A3. The suppression signal generated by the adder 14A4 is about the same as the suppression signal generated by the suppression signal generator 14A2. The waveform of an output signal (an added signal) from the adder 14A4 is illustrated in FIG. 12. In FIG. 12, the vertical axis represents voltage (in volts [V]) and the horizontal axis represents time (in milliseconds [ms]). The waveform of vibration of the liquid crystal display device 11 according to oscillation of the actuator 13 based on the added signal output by the adder 14A4 is illustrated in FIG. 13. The waveform of the vibration of the liquid crystal display device 11 is included in the output signal from the acceleration sensor 11B. FIG. 13 is a graph illustrating the waveform of the vibration of the liquid crystal display device 11 based on the added signal (the base vibration signal and the suppressing signal). In FIG. 13, the vertical axis on the left represents voltage (in volts [V]), the vertical axis on the right represents acceleration (in g [g]), and the horizontal axis represents time (in milliseconds [ms]). As illustrated in FIG. 13, the waveform of the vibration of the liquid crystal display device 11 based on the added signal has the maximum amplitude immediately after start of oscillation of the actuator 13 is slightly less than that of the waveform of the vibration of the liquid crystal display device 11 based on the base vibration signal (see FIG. 7). An amplitude of residual vibration after 10 ms is slightly less than those of the waveform of the vibration of the liquid crystal display device 11 based on the base vibration signal. After 30 ms, it can be said that the residual vibration has disappeared. By driving the actuator 13 based on the suppression signal with the opposite phase from the sections of the waveform of the vibration of the liquid crystal display device 11 that vibrates in conjunction with the oscillation of the actuator 13 based on the base vibration signal, the residual vibration of the liquid crystal display device 11 promptly subsides. According to the configuration, higher tactile feedback performance can be achieved.

As described earlier, the input device 10 includes the liquid crystal display device 11 (the input receptive body), the base 12, the actuator 13 (the oscillator), and the control circuit board 14 (the vibration controller). The liquid crystal display device 11 receives input operation. The liquid crystal display device 11 includes the acceleration sensor 11B for detecting the vibration of the liquid crystal display device 11. The liquid crystal display device 11 is attached to the base 12. The actuator 13 vibrates the liquid crystal display device 11. The control circuit board 14 obtains the waveform of the vibration of the liquid crystal display device 11 based on the output signal from the acceleration sensor 11B and generates the suppression signal with the opposite phase from the phase of at least sections of the waveform of the vibration to control the driving of the actuator 13.

When the base vibration signal is input to the actuator 13 by the control circuit board 14, the actuator 13 starts oscillating. In conjunction with the oscillation, the liquid crystal display device 11 vibrates relative to the base 12. When the acceleration sensor 11B detects the vibration of the liquid crystal display device 11, the acceleration sensor 11B outputs the signal. The control circuit board 14 obtains the waveform of the vibration of the liquid crystal display device 11 based on the output signal from the acceleration sensor 11B and generates the suppression signal with the opposite phase from the phase of at least sections of the waveform of the vibration. If the waveforms of vibration of the liquid crystal display device 11 and the liquid crystal display devices based on base vibration signals are not uniform due to variations between the liquid crystal display device 11 and the other liquid crystal display devices, the residual vibration of the liquid crystal display device 11 promptly subsides because the driving of the actuator 13 is controlled based on the suppression signal generated by the suppressing signal generator 14A2 of the control circuit board 14 based on the waveforms of the vibration, which are periodically obtained. According to the configuration, higher tactile feedback performance can be obtained regardless of the individual differences of the liquid crystal display device 11.

The control circuit board 14 includes the drive circuit 14A and a feedback circuit 14B. The feedback circuit 14B generates the feedback signal based on the output signal from the acceleration sensor 11B. The drive circuit 14A generates the suppression signal based on the feedback signal from the feedback circuit 14B and sends the suppression signal to the actuator 13. When the feedback signal from the feedback circuit 14B is input to the drive circuit 14A, the drive circuit 14A generates the suppression signal and sends the suppression signal to the actuator 13. Feedback control is performed on the driving of the actuator 13.

The drive circuit 14A includes the base vibration signal generator 14A1 and the suppression signal generator 14A2. The base vibration signal generator 14A1 generates the base vibration signal. The suppression signal generator 14A2 generates the suppression signal based on the feedback signal output by the feedback circuit 14B. When the base vibration signal generated by the base vibration signal generator 14A1 is input to the actuator 13, the actuator 13 starts oscillating. With the suppression signal generated by the suppression signal generator 14A2 based on the feedback signal output by the feedback circuit 14B and input to the actuator 13, the feedback control is performed on the driving of the actuator 13.

The feedback circuit 14B includes the half-wave rectifier circuit 14B2 and the gain control circuit 14B3. The half-wave rectifier circuit 14B2 extracts either the positive sections or the negative sections of the waveform of the vibration. The gain control circuit 14B3 amplifies the signal from the half-wave rectifier circuit 14B2 and generates the feedback signal. The feedback signal is the direct-current signal with the positive polarity or the negative polarity. Therefore, the actuator 13 can be driven with the direct current.

The drive circuit 14A outputs the base vibration signal with the positive polarity or the negative polarity and generates the suppression signal with the polarity the same as the polarity of the base vibration signal based on the feedback signal output by the feedback circuit 14B. Because the base vibration signal and the suppression signal are the direct-current signals with the same polarity, the driving of the actuator 13 is easily controlled.

The acceleration of the liquid crystal display device 11 that is vibrating is detected by the acceleration sensor 11B. Tactile feedback to an input body is evaluated based on the acceleration. By detecting the vibration of the liquid crystal display device 11 with the acceleration sensor 11B, the driving of the actuator 13 can be controlled with high accuracy. Therefore, the residual vibration of the liquid crystal display device 11 promptly subsides.

The liquid crystal display device 11 includes the liquid crystal panel 11A1, the touch panel pattern 11TP, and the main controller 11C. The liquid crystal panel 11A1 includes the display surface 11DS on which an image is displayed. The touch panel pattern 11TP is for detecting an input position on the display surface 11DS at which the input operation is performed. The main controller 11C controls the liquid crystal panel 11A1 to display the image on the display surface 11DS based on an input position and control the control circuit board 14 to output a base vibration signal according to the detection of the input position. According to the configuration, when input operation is performed based on an image displayed on the display surface 11DS of the liquid crystal panel 11A1, the input position at which the input operation is performed is detected by the touch panel pattern 11TP. The main controller 11C controls the liquid crystal panel 11A1 to display an image based on the input position detected by the touch panel pattern 11TP. The main controller 11C controls the control circuit board 14 to output a base vibration signal according to the detection of the input position by the touch panel pattern 11TP. Namely, the image display along with the input operation by the input body and the tactile feedback through the driving of the driver are performed in conjunction with each other.

The input device includes the elastic members 15 attached to the liquid crystal display device 11 and the base 12 to be elastically deformable at least in the oscillation direction of the actuator 13. When the actuator 13 oscillates, the elastic members 15 attached to the liquid crystal display device 11 and the base 12 elastically deform in the oscillation direction of the actuator 13. According to the configuration, movement of the liquid crystal display device 11 relative to the base 12 in the vibration direction is allowed. The elastic members 15 may have differences in characteristics including elastic constants from other elastic members. Such difference may affect the waveform of the vibration of the liquid crystal display device 11. Because the control circuit board 14 controls the driving of the actuator 13 based on the suppression signal generated based on the waveform of the vibration of the liquid crystal display device 11, the residual vibration of the liquid crystal display device 11 promptly subsides even if the individual differences of the elastic members 15 are present.

### OTHER EMBODIMENTS

The technology described herein is not limited to the embodiments described above and with reference to the drawings. The following embodiments may be included in the technical scope.

(1) An inverting type half-wave rectifier circuit and an inverting type gain control circuit may be used of the feedback circuit instead of the non-inverting type half-wave rectifier circuit and the non-inverting type gain control circuit.

(2) The feedback circuit may be configured to perform the half-wave rectifying function and the gain control function by a single circuit.

(3) The base vibration signal generator may be configured to generate base vibration signals with a negative polarity. In this case, the feedback circuit (or the half-rectifier circuit) may be configured to extract the positive sections of the waveform of the vibration of the liquid crystal display device (i.e., with an opposite polarity from that of the base vibration signals).

(4) The drive circuit may be configured to generate suppression signals with the same polarity as that of the feedback signals. In this case, the feedback circuit (or the half-wave rectifier circuit) may be configured to extract positive sections of the waveform of the vibration of the liquid crystal display device (i.t., with the same polarity as that of the base vibration signals).

(5) The actuator may be configured to oscillate on either side with respect to the X-axis direction. In this case, the feedback circuit may be configured to extract both positive sections and negative sections of a waveform of vibration of the liquid crystal display device and to generate feedback signals based on the positive and the negative sections of the waveform. The drive circuit may be configured to generate suppression signals with an opposite polarity from the polarity of the vibration of the liquid crystal display device based on the feedback signals. The suppression signals are alternating-current signals. The base vibration signals are also alternating-current signals.

(6) The oscillating direction of the actuator may be set parallel to a normal direction to the display surface of the liquid crystal panel (or the input direction of touch operation).

(7) For detection of the acceleration, servo type acceleration sensors, strain-gauge type acceleration sensors, semiconductor type acceleration sensors, and capacitance type acceleration other than the piezoelectric type acceleration sensor may be used. Furthermore, acceleration sensors with double or triple detection axes may be used.

(8) Displacement sensors may be used for measuring an amount of displacement due to the vibration of the liquid crystal display device to detect the vibration instead of the acceleration sensor.

(9) Elastic members other than the plate springs may be used.

(10) Inertial drive actuators including piezo actuators and linear actuators may be used instead of the electromagnetic actuator. The inertial drive actuator may be disposed on the liquid crystal display device but the base. Furthermore, other types of actuators can be used.

(11) A touch panel including an out-cell touch panel pattern on a surface of a liquid crystal panel may be used.

(12) An mutual capacitance type touch panel pattern may be used. The touch electrodes of the touch panel pattern may be altered from the rectangular shape to a diamond shape, a round shape, a pentagonal shape, or any of polygonal shapes.

(13) The technology described herein may be applied to liquid crystal display devices that do not include touch panel patterns.

(14) The two-dimensional shape of the input device may be altered to a vertically-long rectangular shape, a square shape, an oval shape, an elliptical shape, a circular shape, a trapezoidal shape, and a shape with curves.

(15) The technology described herein may be applied to other types of display panels including plasma display panels (PDPs), organic light-emitting diode display panels, electrophoretic display (EPD) panels and micro electro mechanical systems (MEMS) display panels.

1. An input device comprising:
an input receptive body configured to receive input operation;
a base attached to the input receptive body;
an oscillator configured to vibrate the input receptive body;
a vibration detector configured to detect vibration of the input receptive body; and
a vibration controller configured to:
output a base vibration signal to oscillate the oscillator with which the input receptive body vibrates;
obtain a waveform of the vibration of the input receptive body based on an output signal from the vibration detector; and
generate a suppression signal with an opposite phase from a phase of at least a section of the waveform of the vibration to control driving of the oscillator.

2. The input device according to claim 1, wherein the vibration controller comprises:
a feedback circuit configured to generate a feedback signal based on an output signal from the vibration detector; and
a drive circuit configured to generate the suppression signal based on the feedback signal and output the suppressing signal to the oscillator.

3. The input device according to claim 2, wherein the drive circuit comprises:
a base vibration signal generator configured to generate a base vibration signal; and
a suppression signal generator configured to generate the suppression signal based on the feedback signal output by the feedback circuit.

4. The input device according to claim 2, wherein the feedback circuit comprises:
a half-wave rectifier circuit configured to extract either one of positive and negative sections of the waveform of the vibration; and
a gain control circuit configured to amplify a signal output by the half-wave rectifier circuit and generate the feedback signal.

5. The input device according to claim 4, wherein the drive circuit is configured to:
output the base vibration signal with either one of positive and negative polarities; and
generate the base vibration signal with a polarity the same as the polarity of the base vibration signal based on the feedback signal output by the feedback circuit.

6. The input device according to claim 1, wherein the vibration detector includes an acceleration sensor.

7. The input device according to claim 1, wherein the input receptive body comprises:
a display panel configured to display an image;
a touch panel pattern configured to detect an input position at which the input operation is performed on the display surface; and
a main controller configured to control the display panel to display an image on the display surface based on the input position and control the vibration controller to output the base vibration signal according to detection of the input position.

8. The input device according to claim 1, further comprises an elastic member attached to the input receptive body and the base and elastically deformable in a direction in which the oscillator oscillates.
